(19) United States
(12) Patent Application Publication
(10) Pub. No.: US 2021/0377102 A1
(43) Pub. Date: Dec. 2, 2021

(54) A METHOD AND SYSTEM FOR DETECTING A SERVER FAULT

(71) Applicant: WANGSU SCIENCE & TECHNOLOGY CO., LTD., Shanghai (CN)

(72) Inventors: Wenjie WU, Shanghai (CN); Jianzhan YU, Shanghai (CN); Jie LI, Shanghai (CN)

(21) Appl. No.: 16/330,961

(22) PCT Filed: May 24, 2018
(86) PCT No.: PCT/CN2018/088240

§ 371 Date: Mar. 6, 2019

(30) Foreign Application Priority Data
Mar. 9, 2018 (CN) 201810193351.7

(51) Int. Cl. H04L 12/24

(52) U.S. Cl. CPC H04L 41/0677; H04L 41/147; H04L 41/0631

(57) ABSTRACT

A method for detecting a server fault includes: collecting sample monitoring data of a plurality of servers, the sample monitoring data signifying operating states of the plurality of servers; performing training, based on the sample monitoring data, to obtain a fault detection model for the plurality of servers; and collecting current monitoring data of a target server, and inputting the current monitoring data into the fault detection model to determine an operating fault corresponding to the current monitoring data.

### FIELD OF DISCLOSURE

The present disclosure generally relates to the field of Internet technology and, more particularly, relates to a method and system for detecting a server fault.

### BACKGROUND

With the continuous development of Internet technology, the number of servers in the network is also increasing. The performance of a server may directly affect the quality of the services it provides. When a server has a fault, the cause of the fault needs to be found out in time so that the fault can be fixed timely.

Currently, servers usually have a fault alarm mechanism. When a server is abnormal, the server will issue an alarm notice. In this way, the server administrator may inspect the server to find out which component has an anomaly.

However, as the number of servers continues to increase, if the faults on the servers are detected only by manual troubleshooting, a lot of human and material resources will be wasted, and the efficiency of fault detection is also low.

### BRIEF SUMMARY OF THE DISCLOSURE

The objective of the present disclosure is to provide a method and system for detecting a server fault, which can improve the efficiency of fault detection.

To achieve the above objective, in one aspect, the present disclosure provides a method for detecting a server fault. The method includes: collecting sample monitoring data of a plurality of servers, the sample monitoring data signifying operating states of the plurality of servers; performing training, based on the sample monitoring data, to obtain a fault detection model for the plurality of servers; and collecting current monitoring data of a target server, and inputting the current monitoring data into the fault detection model to determine an operating fault corresponding to the current monitoring data.

To achieve the above objective, in another aspect, the present disclosure further provides a system for detecting a server fault. The system includes a data collecting unit, a data processing unit, and a fault detecting unit, where: the data collecting unit is configured to collect sample monitoring data of a plurality of servers, the sample monitoring data signifying operating states of the plurality of servers; the data processing unit includes a big data platform and a model training module, where the big data platform is configured to receive the sample monitoring data sent by the data collecting unit, and the model training module is configured to, based on the sample monitoring data, perform training to obtain a fault detection model for the plurality of servers; and the fault detecting unit is configured to collect current monitoring data of a target server, and input the current monitoring data into the fault detection model to determine an operating fault corresponding to the current monitoring data.

As can be seen from the above, the technical solutions provided by the present disclosure may provide a machine learning method that is based on the sample monitoring data of multiple servers to perform training to obtain a fault detection model for the servers. Specifically, the sample monitoring data may include various aspects of server data, such as power supply data, temperature data, fan data, port data, network link data, system event data, and system service data. When determining a specific fault for a target server or predicting a fault of the target server, current monitoring data of the target server may be collected, and the current monitoring data is input into the fault detection model obtained through the training. Finally, the result output by the fault detection model may signify an operating fault corresponding to the current monitoring data. In real applications, for each type of monitoring data, a corresponding sub-model may be obtained through the training. In this way, for the input monitoring data, a matching sub-model may be selected for the fault detection, thereby improving the accuracy of fault detection. It can be seen from the above that the technical solutions provided by the present disclosure may save a lot of human and material resources, and may improve the efficiency of fault detection.

### BRIEF DESCRIPTION OF THE DRAWINGS

To make the technical solutions in the embodiments of the present disclosure clearer, a brief introduction of the accompanying drawings consistent with descriptions of the embodiments will be provided hereinafter. It is to be understood that the following described drawings are merely some embodiments of the present disclosure. Based on the accompanying drawings and without creative efforts, persons of ordinary skill in the art may derive other drawings.

FIG. 1 is a flowchart of a method for detecting a server fault according to some embodiments of the present disclosure;

FIG. 2 is a schematic diagram of an example of a system for detecting a server fault according to some embodiments of the present disclosure;

FIG. 3 is a schematic structural diagram of a system for detecting a server fault according to some embodiments of the present disclosure; and

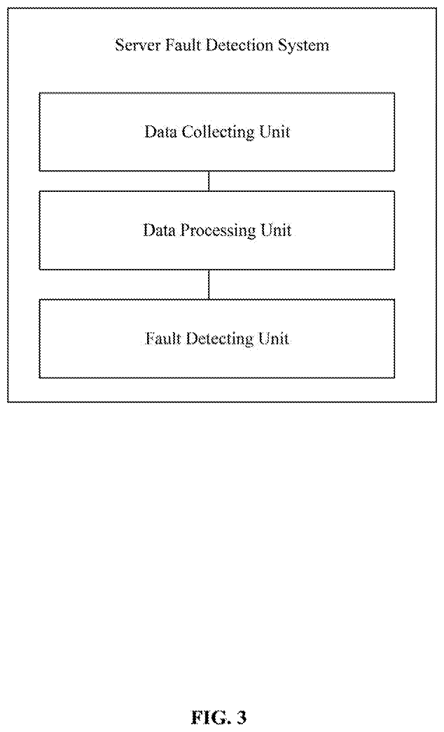

FIG. 4 is a schematic structural diagram of a computer terminal according to some embodiments of the present disclosure.

### DETAILED DESCRIPTION

To make the objective, technical solutions, and advantages of the present disclosure clearer, the embodiments of the present disclosure will be made in detail hereinafter with reference to the accompanying drawings.

### Embodiment 1

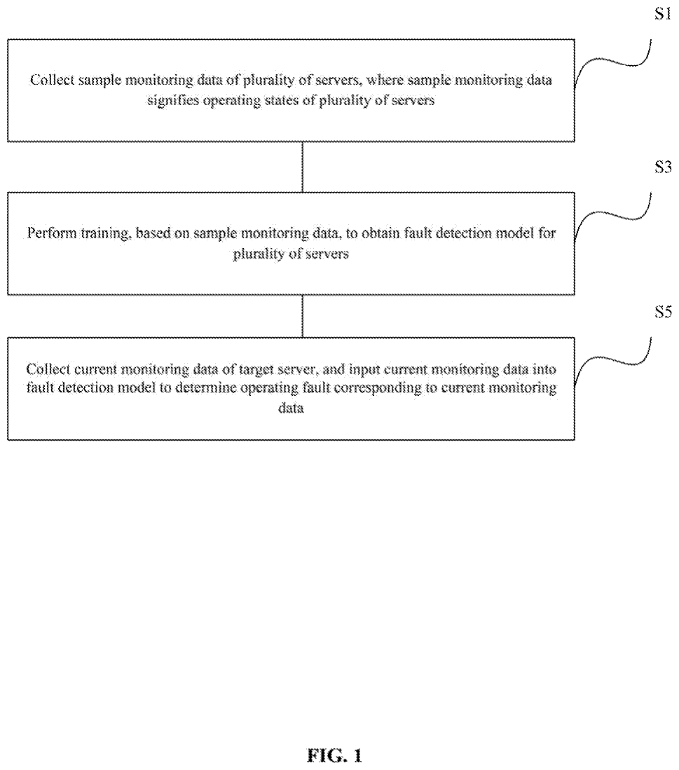

The present disclosure provides a method for detecting a server fault. Referring to FIG. 1, the method may include the following steps.

S1: collecting sample monitoring data from a plurality of servers, where the sample monitoring data signifies operating states of the plurality of servers.

In the disclosed embodiment, through predefined collection probes, monitoring data that signify the operating states of servers may be collected from a plurality of online servers. The monitoring data may include various aspects of data of the plurality of servers, such as CDM monitoring data, power supply data, temperature data, fan data, port data, network link data, system event data, and system service data. Here, the CDM monitoring data includes CPU (Central Processing Unit) monitoring data, DISK (hard drive) monitoring data, and MEMORY monitoring data. The foregoing data may reflect whether the servers are in normal operating states. After analyzing the data, operating fault(s) currently existed in the servers may be determined.

In the disclosed embodiment, the predefined collection probes may be preset collection devices. The collection devices may read the monitoring data from the servers through data transmission protocol(s) agreed with the servers. The monitoring data read by the collection devices may be used as sample monitoring data for machine learning. By learning a large amount of the sample monitoring data, various types of fault features may be analyzed.

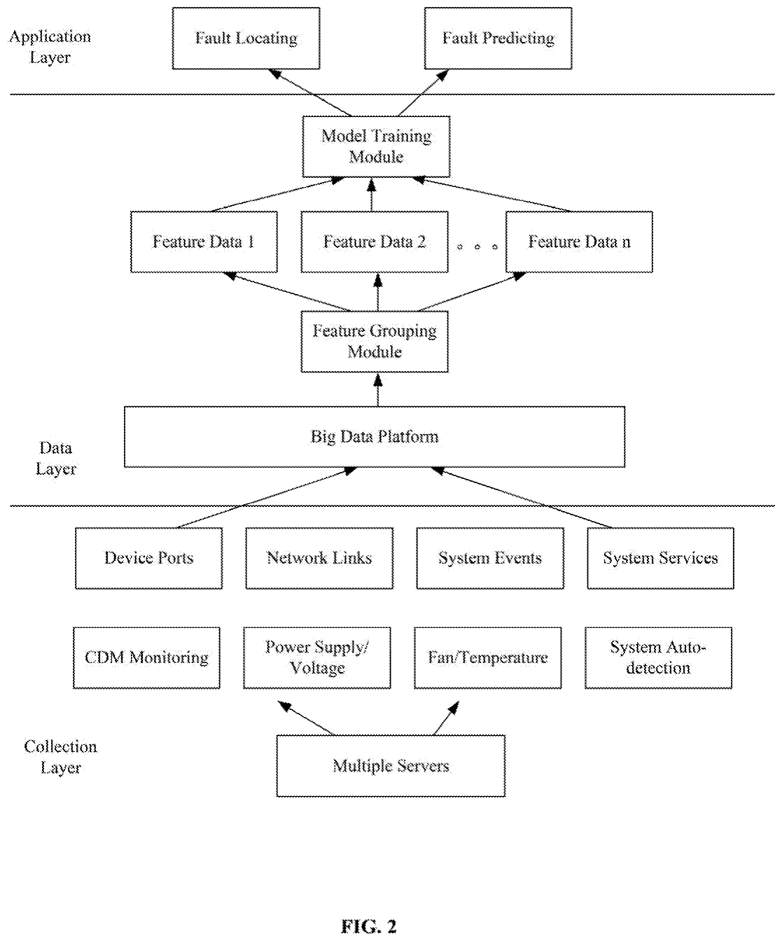

Referring to FIG. 2, in the disclosed embodiment, the process of collecting sample monitoring data may be implemented in a data collection layer. The data collection layer collects the sample monitoring data by collecting the data recorded on a Baseboard Management Controller (BMC) through an Intelligent Platform Management Interface (IPMI), formatting the collected data, and uploading the formatted data to a big data platform.

S3: performing training based on the sample monitoring data to obtain a fault detection model for the plurality of servers.

In the disclosed embodiment, after receiving the sample monitoring data uploaded by the collection layer, the big data platform may train a fault detection model using a machine learning method based on the sample monitoring data. In real applications, the collected sample monitoring data generally includes various types of monitoring data as described in Step S1. Here, each type of monitoring data may be used as a group of feature data, and thus the sample monitoring data may include multiple groups of feature data. For example, the sample monitoring data may be classified into a group of power supply feature data, a group of fan feature data, a group of memory feature data, and the like.

In one embodiment, in order to accurately locate a fault occurring in a server, the sample monitoring data may be grouped based on feature data and respectively trained to obtain a sub-model for each group of feature data. For example, for a group of power supply feature data, a power supply fault detection sub-model may be obtained through the training; and for a group of memory feature data, a memory fault detection sub-model may be obtained through the training. It should be noted that, in order to ensure a sub-model obtained through the training to be accurate, each group of feature data may include multiple pieces of feature data. The multiple pieces of feature data may be operating data of the same server at different time periods, or the operating data from different servers. For example, a group of memory feature data may include 1000 pieces of memory data collected from 100 servers.

In the disclosed embodiment, when performing a sub-model training for each group of feature data, each piece of feature data may be associated in advance with a standard operating fault, where the standard operating fault may be obtained through analyzing the feature data. Accordingly, an associated standard operating fault is an operating fault reflected by that piece of feature data. At the beginning of the training, the feature data may be input into an initial detection sub-model, to obtain a predicted operating fault for the feature data. Here, the initial detection sub-model may include an initialized neural network, and the neurons in the initialized neural network may have initial parameter values. Since the initial parameter values are set by default, the predicted operating fault resulted from processing the input feature data based on these initial parameter values may be not consistent with the standard operating fault that is actually reflected by the feature data. Accordingly, an error between the predicted operating fault and the standard operating fault may be determined. Specifically, the predicted result obtained by the initial detection sub-model may be a predicted probability array. The predicted probability array may include multiple probability values, where each probability value may correspond to one type of fault. For example, for a piece of memory feature data, the eventually obtained predicted probability array may include three probability values, and the three probability values respectively correspond to three types of fault related to the memory. Among these values, the higher the probability value, the greater the possibility that there is a corresponding type of fault. For example, if the predicted probability array is (0.1, 0.6, 0.3), then the type of fault corresponding to 0.6 may be the predicted operating fault. The standard probability array corresponding to the standard operating fault associated with the feature data may be, for example, (1, 0, 0), where the type of fault corresponding to the probability value 1 may be the standard operating fault. In this way, by subtracting the probability values of the predicted probability array from the corresponding probability values of the standard probability array, an error between the predicted operating fault and the standard operating fault may be determined. By inputting the error as a feedback value into the initial detection sub-model, the parameter values in the initial detection sub-model may be adjusted. After the adjustment, the feature data may be re-input into the adjusted detection sub-model. The process of error-based adjustment of the parameter values of the sub-model may be repeated, to allow the eventually predicted operating fault to be consistent with the standard operating fault. In this way, through the repeated training of a sub-model using a large amount of feature data in each group of feature data, the final sub-models obtained through the training may have a high prediction accuracy.

In one embodiment, the feature data may signify the operating state of a component in a server. For example, the CPU data may signify the operating state of a CPU. The feature data may also include a plurality of feature sub-data. The plurality of feature sub-data may respectively signify a state of each aspect of the component at running time. For example, the CPU data may include feature sub-data such as a CPU usage, a time-length of the CPU being used, a number of threads used by the CPU, etc. When the feature data is trained, a decision order of each feature sub-data in the feature data may be determined using a decision tree technique. According to the decision order, a feature value corresponding to each feature sub-data is determined. Here, the feature value is used to represent a specific value in the decision steps. For example, for the CPU data, the decision order determined based on the decision tree technique is to first determine the CPU usage, then determine the number of threads used by the CPU, and finally determine the time length of the CPU being used. Then, in each decision step, a value obtained by the decision may be considered as the above-mentioned feature value. For example, in the CPU usage decision step, the feature value may be 80%.

In the disclosed embodiment, based on the feature values determined by the decision, a predicted probability array corresponding to the feature data may be calculated. Specifically, the decision process may be performed by a neural network. The neurons in the neural network may perform a weighted summation or other non-linear calculations based on the feature value of each decision step to determine a final predicted probability array. The predicted probability array may include at least one probability value, where each primality value corresponds to a type of fault. For example, for the memory data, the predicted probability array finally determined from the prediction may include three probability values. The three probability values respectively correspond to three types of fault related to the memory. Eventually, the type of fault corresponding to the largest probability value in the predicted probability array may be determined as the predicted operating fault. For example, if the predicted probability array is (0.1, 0.6, 0.3), then the type of fault corresponding to 0.6 would be the predicted operating fault.

As shown in FIG. 2, in the disclosed embodiment, the training process of the fault prediction model may be implemented in a data layer. The data layer may include the big data platform described above, and may also include a feature grouping module and a model training module. Here, the feature grouping module is configured to group the sample monitoring data in the big data platform based on the feature data. The grouped feature data may be respectively trained in the model training module to obtain respective sub-models.

S5: collecting current monitoring data of a target server, and inputting the current monitoring data into the fault detection model to determine an operating fault corresponding to the current monitoring data.

In the disclosed embodiment, after performing training to obtain the fault detection model, current monitoring data of a target server may be collected, and the fault detection model obtained through the training may be used to perform fault detection on the current monitoring data. The target server may be a server to be examined. In the disclosed embodiment, the current monitoring data of the target server may also be collected using a preset collection probe. The current monitoring data may also include multiple groups of feature data. Accordingly, after collecting the current monitoring data of the target server, target feature data included in the current monitoring data may be identified. The target feature data is then input into a matching sub-model to determine an operating fault corresponding to the target feature data. In this way, for each group of feature data, a corresponding operating fault may be determined, which may then be pooled together to get each operating fault of the target server eventually.

As shown in FIG. 2, in the disclosed embodiment, the above-described fault detection process may be implemented in an application layer. In the application layer, in addition to locating a fault in a server that already has a fault, the server may be also periodically checked for an early sign of possible server fault(s), so that timely inspection and repair can be performed.

In one embodiment, the timing for collecting the current monitoring data of the target server may also have different options. In one aspect, the current monitoring data of the target server may be collected when the target server itself issues a fault notification message. The purpose of this processing is that the fault notification message sent by the target server usually includes relatively broad information. The message may only notify that the target server currently has a fault, but does not specify the specific type of the fault. At this point, in order to quickly screen a location of the fault, the current monitoring data may be collected, and the detailed fault information may be obtained using the fault detection model obtained through the training. In another aspect, the current monitoring data of the target server may also be periodically collected according to a specified time period. Each collected monitoring data is then detected for fault using the fault detection model obtained through the training. The purpose of this processing is to periodically perform a fault detection on the target server, so that it may be predicted whether there is a tendency that the target server will have a fault. This will allow the inspection and repair to be performed before a fault occurs.

In one embodiment, in order not to affect the normal network service of the target server, the target server may be detected for fault when the target server is idle. Specifically, a load distribution of the target server may be determined. The load distribution may include average loads of the target server within specified time periods. For example, an average load of the target server may be determined every three hours in a day. A target time period may then be determined based on the load distribution, and the fault detection may be performed on the target server within the target time period. Here, the average load within the target time period may be relatively low. Specifically, a specified time period corresponding to an average load less than or equal to a specified load threshold may be considered as the target time period. The specified load threshold may be set as, for example, 50%. Clearly, the specified load threshold may be flexibly adjusted based on the real situations. In actual applications, if the number of specified time periods corresponding to an average load less than or equal to the specified load threshold is at least two, then one of the specified time periods may be randomly selected as the target time period, or one of the specified time periods that has the lowest average load may be considered as the target time period. For example, after calculating the average loads of the target server every three hours in a day, it is found that that the time periods with an average load less than or equal to 50% fall in 0:00 am-3:00 am and 3:00 am-6:00 am. Either time period may then be considered as the target time period. Since the load of the target server is low during the target time period, the current running parameters of the target server may be collected and fault detection may be performed during this period without greatly affecting the performance of the target server.

In one embodiment, after determining an operating fault corresponding to the current monitoring data, a diagnostic strategy matching the operating fault may be invoked and applied to diagnose the fault of the target server. Here, the diagnosis strategy may be a strategy that is generalized based on the past diagnostic history. Each diagnosis strategy may be stored in association with a corresponding operating fault. In this way, after detecting an operating fault, the associated diagnostic strategy may be invoked for the detailed diagnosis. For example, the severity of the operating fault and the frequency of the operating fault may be diagnosed. Based on the result of the fault diagnosis, a detection cycle for the target server may be determined, and the target server may be periodically detected for fault based on the detection cycle. The detection cycle may be set according to the severity of the operating fault and the frequency of the fault. The more serious the operating fault, the higher the frequency of fault, the shorter the detection cycle may be. This may ensure an operating fault of the target server to be identified in time, so that the prevention and repair may be conducted before the fault occurs.

### Embodiment 2

The present disclosure further provides a system for detecting a server fault. The system includes a data collecting unit, a data processing unit, and a fault detecting unit, where:

the data collecting unit is configured to collect sample monitoring data of a plurality of servers, the sample monitoring data signifying operating states of the plurality of servers;

the data processing unit includes a big data platform and a model training module, where the big data platform is configured to receive the sample monitoring data sent by the data collecting unit, and the model training module is configured to, based on the sample monitoring data, perform training to obtain a fault detection model for the plurality of servers; and

the fault detecting unit is configured to collect current monitoring data of a target server, and input the current monitoring data into the fault detection model to determine an operating fault corresponding to the current monitoring data.

In one embodiment, the sample monitoring data includes a plurality of groups of feature data. Correspondingly, the data processing unit further includes:

a feature grouping module that is configured to group the sample monitoring data according to feature data, to allow the model training module to respectively perform training to obtain a sub-model for each group of feature data.

In one embodiment, the feature data is associated with a standard operating fault. Corresponding, the model training module further includes:

an initial prediction module that is configured to input the feature data into an initial detection sub-model to obtain a predicted operating fault of the feature data; and

an error correction module that is configured to determine an error between the predicted operating fault and the standard operating fault, and adjust parameters of the initial detection sub-model based on the error, to allow the predicted operating fault to be consistent with the standard operating fault after the feature data is re-input into the adjusted detection sub-model.

In one embodiment, the feature data includes a plurality of feature sub-data. Correspondingly, the initial prediction module further includes:

a decision order determining module that is configured to determine a decision order of each feature sub-data in the feature data, and respectively determine a feature value corresponding to each feature sub-data according to the decision order;

a probability array calculating module that is configured to calculate, according to the feature value, a predicted probability array corresponding to the feature data, where the predicted probability array includes at least one probability value, and each probability value corresponds to a type of fault; and

a fault determining module that is configured to determine a type of fault corresponding to the largest probability value in the predicted probability array as the predicted operating fault.

In one embodiment, the system further includes:

a load distribution calculating unit that is configured to calculate a load distribution of the target server, where the load distribution includes average loads of the target server within specified time periods; and

a periodic detection module that is configured to determine a target time period based on the load distribution, and perform a fault detection on the target server within the target time period.

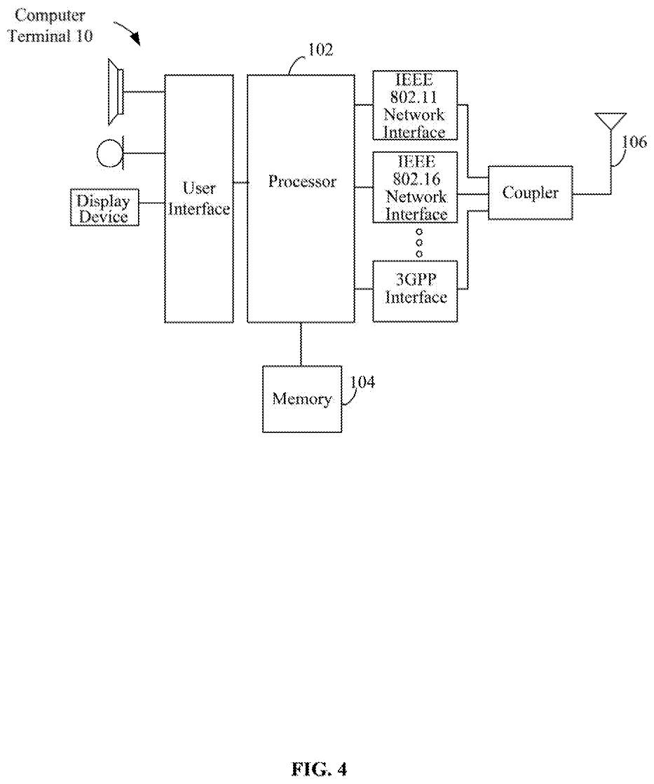

Referring to FIG. 4, in the present disclosure, the technical solutions of the disclosed embodiments may be applied to a computer terminal 10 shown in FIG. 4. The computer terminal 10 may include one or more (only one is shown in the figure) processors 102 (a processor 102 may include, but is not limited to, a processing device such as a micro-controller MCU or a programmable logic device FPGA), a memory 104 for storing data, and a transmission device 106 for communication purpose. It will be understood by those skilled in the art that the structure shown in FIG. 4 is provided by way of illustration, but not by way of limitation of the structures of the above-described electronic devices. For example, the computer terminal 10 may also include more or fewer components than those shown in FIG. 4, or have a different configuration than that shown in FIG. 4.

The memory 104 may be used to store software programs and modules of application software. The processor 102 implements various functional applications and data processing by executing software programs and modules stored in the memory 104. The memory 104 may include a high-speed random access memory, and also a non-volatile memory, such as one or more magnetic storage devices, flash memory, or other non-volatile solid-state memory. In some applications, the memory 104 may further include a memory remotely disposed with respect to the processor 102, which may be connected to the computer terminal 10 through a network. Examples of such network include, but are not limited to, the Internet, an intranet, a local area network, a mobile communication network, and combinations thereof.

Specifically, in the present disclosure, the above-described methods for detecting a server fault may be stored as a computer program in the above-described memory 104. The memory 104 may be coupled to the processor 102. Accordingly, when the processor 102 executes the computer program in the memory 104, each step in the above-described methods for detecting a server fault may be implemented.

The transmission device 106 is configured to receive or transmit data via the network. The aforementioned specific examples of the network may include a wireless network provided by the communication provider of the computer terminal 10. In one application, the transmission device 106 includes a network interface controller (NIC) that may be connected to other network devices through the base stations to allow it to communicate with the Internet. In one application, the transmission device 106 may be a Radio Frequency (RF) module that is configured to communicate with the Internet via a wireless approach.

The BMC 108 functions as follows: when the collection layer collects sample monitoring data, the data recorded on the BMC may be collected through the IPMI, the collected data is formatted, and then uploaded to the big data platform.

As can be seen from the above, the technical solutions provided by the present disclosure may provide a machine learning method that is based on the sample monitoring data of multiple servers to perform training to obtain a fault detection model for the servers. Specifically, the sample monitoring data may include various aspects of server data, such as power supply data, temperature data, fan data, port data, network link data, system event data, and system service data. When determining a specific fault for a target server or predicting a fault of the target server, current monitoring data of the target server may be collected, and the current monitoring data is input into the fault detection model obtained through the training. Finally, the result output by the fault detection model may signify an operating fault corresponding to the current monitoring data. In real applications, for each type of monitoring data, a corresponding sub-model may be obtained through the training. In this way, for the input monitoring data, a matching sub-model may be selected for the fault detection, thereby improving the accuracy of fault detection. It can be seen from the above that the technical solutions provided by the present disclosure may save a lot of human and material resources, and may improve the efficiency of fault detection.

Through the foregoing description of the embodiments, it is clear to those skilled in the art that the various embodiments may take the form of a software plus a necessary general hardware platform implementation, and entirely a hardware implementation. In light of this understanding, the technical solutions, or essentially the parts that contribute to the current technology, may be embodied by way of a software product. The computer software product may be stored in a computer-readable storage medium, such as a ROM/RAM, a magnetic disc, an optical disc, etc., and include a variety of programs that cause a computing device (which may be a personal computer, a server, or a network device, etc.) to implement each embodiment or methods described in certain parts of each embodiment.

Although the present disclosure has been described as above with reference to preferred embodiments, these embodiments are not constructed as limiting the present disclosure. Any modifications, equivalent replacements, and improvements made without departing from the spirit and principle of the present disclosure shall fall within the scope of the protection of the present disclosure.

What is claimed is:

1. A method for detecting a server fault, comprising:
collecting sample monitoring data of a plurality of servers, the sample monitoring data signifying operating states of the plurality of servers;
performing training, based on the sample monitoring data, to obtain a fault detection model for the plurality of servers; and
collecting current monitoring data of a target server, and inputting the current monitoring data into the fault detection model to determine an operating fault corresponding to the current monitoring data.

2. The method according to claim 1, wherein the sample monitoring data includes a plurality of groups of feature data, and performing training to obtain the fault detection model for the plurality of servers further includes:
grouping the sample monitoring data according to feature data, and respectively performing training to obtain a sub-model for each group of feature data.

3. The method according to claim 2, after collecting the current monitoring data of the target server, the method further includes:
identifying target feature data included in the current monitoring data, and inputting the target feature data into a matching sub-model to determine an operating fault corresponding to the target feature data.

4. The method according to claim 2, wherein the feature data is associated with a standard operating fault, and performing training to obtain a sub-model for each group of feature data further includes:
inputting the feature data into an initial detection sub-model to obtain a predicted operating fault of the feature data; and
determining an error between the predicted operating fault and the standard operating fault, and adjusting parameters of the initial detection sub-model based on the error, to allow the predicted operating fault to be consistent with the standard operating fault after the feature data is re-input into the adjusted detection sub-model.

5. The method according to claim 4, wherein the feature data includes a plurality of feature sub-data, and determining the predicted operating fault further includes:
determining a decision order of each feature sub-data in the feature data, and respectively determining a feature value corresponding to each feature sub-data according to the decision order;
calculating a predicted probability array corresponding to the feature data based on the feature value corresponding to each feature sub-data, wherein the predicted probability array includes at least one probability value, and each probability value corresponds to a type of fault; and
determining a type of fault corresponding to the largest probability value in the predicted probability array as the predicted operating fault.

6. The method according to claim 1, wherein collecting the current monitoring data of the target server further includes:
collecting the current monitoring data of the target server when the target server issues a fault notification message; or
collecting the current monitoring data of the target server according to a specified time cycle.

7. The method according to claim 1, further comprising:
calculating a load distribution of the target server, wherein the load distribution includes average loads of the target server within specified time periods; and
determining a target time period based on the load distribution, and performing a fault detection on the target server within the target time period.

8. The method according to claim 7, wherein determining the target time period based on the load distribution further includes:
determining a specified time period corresponding to an average load less than or equal to a specified load threshold as the target time period, and if the number of specified time periods corresponding to an average load less than or equal to the specified load threshold is at least two, randomly selecting one of the specified time periods as the target time period, or determining a specified time period corresponding to the lowest average load as the target time period.

9. The method according to claim 1, after determining the operating fault corresponding to the current monitoring data, the method further includes:
invoking a diagnostic strategy that matches the operating fault, and applying the diagnostics strategy to diagnose the operating fault of the target server; and
determining a detection cycle for the target server based on a result of the fault diagnosis, and periodically performing a fault detection on the target server based on the detection cycle.

10. A system for detecting a server fault, comprising a data collecting unit, a data processing unit, and a fault detecting unit, wherein:
the data collecting unit is configured to collect sample monitoring data of a plurality of servers, the sample monitoring data signifying operating states of the plurality of servers;
the data processing unit includes a big data platform and a model training module, wherein the big data platform is configured to receive the sample monitoring data sent by the data collecting unit, and the model training module is configured to, based on the sample monitoring data, perform training to obtain a fault detection model for the plurality of servers; and
the fault detecting unit is configured to collect current monitoring data of a target server, and input the current monitoring data into the fault detection model to determine an operating fault corresponding to the current monitoring data.

11. The system according to claim 10, wherein the sample monitoring data includes a plurality of groups of feature data, and the data processing unit further includes:
a feature grouping module that is configured to group the sample monitoring data according to feature data, to allow the model training module to respectively perform training to obtain a sub-model for each group of feature data.

12. The system according to claim 11, wherein the feature data is associated with a standard operating fault, and the model training module further includes:
an initial prediction module that is configured to input the feature data into an initial detection sub-model to obtain a predicted operating fault of the feature data; and
an error correction module that is configured to determine an error between the predicted operating fault and the standard operating fault, and adjust parameters of the initial detection sub-model based on the error, to allow the predicted operating fault to be consistent with the standard operating fault after the feature data is re-input into the adjusted detection sub-model.

13. The system according to claim 12, wherein the feature data includes a plurality of feature sub-data, and the initial prediction module further includes:
a decision order determining module that is configured to determine a decision order of each feature sub-data in the feature data, and respectively determine a feature value corresponding to each feature sub-data according to the decision order;
a probability array calculating module that is configured to calculate, according to the feature value, a predicted probability array corresponding to the feature data, wherein the predicted probability array includes at least one probability value, and each probability value corresponds to a type of fault; and
a fault determining module that is configured to determine a type of fault corresponding to the largest probability value in the predicted probability array as the predicted operating fault.

14. The system according to claim 10, further comprising:
a load distribution calculating unit that is configured to calculate a load distribution of the target server, wherein the load distribution includes average loads of the target server within specified time periods; and
a periodic detection module that is configured to determine a target time period based on the load distribution, and perform a fault detection on the target server within the target time period.
